(19) United States
(12) Patent Application Publication
(10) Pub. No.: US 2026/0148184 A1
(43) Pub. Date: May 28, 2026

(54) NODE INVENTORY LEVEL

(71) Applicant: Walmart Apollo, LLC, Bentonville, AR (US)

(72) Inventors: Hoda Parvin, Seattle, WA (US); Fiona Chehong Yeung, San Francisco, CA (US); Arash Sangari, Frisco, TX (US); Shaun Robert Rorrison, Bentonvile, AR (US); Andrew Michael Churchill, Poolesville, MD (US); Sergey Orshanskiy, State College, PA (US); Bjarni Magnusson, Bentonville, AR (US); Sarah Luanne Im, Rogers, AR (US); Taylor James Toolson, Centerton, AR (US); Shui Yu, Santa Monica, CA (US); Kenneth David Kuhn, Pasadena, CA (US); Anantha Ravi Kiran Lanka Subrahmanya, San Jose, CA (US); Sailee Sanjay Gawande, San Jose, CA (US)

(21) Appl. No.: 18/961,030

(22) Filed: Nov. 26, 2024

(51) Int. Cl. G06Q 10/087; G06Q 30/0202

(52) U.S. Cl. CPC G06Q 10/087; G06Q 30/0202

(57) ABSTRACT

Examples relate to managing node inventory levels are disclosed. An example may involve: obtaining historical data of items at a node in a network for a past time period; generating a supply chain lead time variability for an item at the node based on the historical data; generating a demand variability for the item at the node based on the historical data and the supply chain lead time variability; generating, based on the supply chain lead time variability and the demand variability, a recommended inventory level of the item in the node for a future time period; and transmitting the recommended inventory level to a computing device associated with the node for inventory arrangement in the future time period.

### TECHNICAL FIELD

This disclosure relates to systems and methods for managing node inventory level.

### BACKGROUND

Approaches in node supply management include: assuming constant supply lead time, trusting the demand forecast, allocating no safety inventory to lower the risk of on-hand excess stock, and using the same standard safety supply formula to apply across different business units, which may not account for scenario-specific upstream uncertainties, failures and requirements.

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for optimizing inventory target level of products, in accordance with some embodiments;

FIG. 2 is a block diagram of an inventory level recommendation device, in accordance with some embodiments;

FIG. 3 is a block diagram illustrating various portions of a system for optimizing inventory target level of products, in accordance with some embodiments;

FIG. 4 illustrates an example architecture of a system for optimizing product inventory target level, in accordance with some embodiments;

FIG. 5 illustrates an example process performed by a system for optimizing product inventory target level, in accordance with some embodiments;

FIG. 6 illustrates an example process for lead time variability estimation, in accordance with some embodiments;

FIG. 7 illustrates an example process for estimating item-node level demand variability, in accordance with some embodiments;

FIG. 8 illustrates an example probability distribution computed for excess demand, in accordance with some embodiments;

FIG. 9 illustrates example cost functions used for optimizing product inventory target level, in accordance with some embodiments;

FIG. 10 illustrates example relationships between customer service and inventory levels, in accordance with some embodiments;

FIG. 11 shows a flowchart illustrating an example method for optimizing inventory target level of products, in accordance with some embodiments.

FIG. 12 depicts an example system with a machine-readable medium that includes instructions for optimizing inventory target level of products, in accordance with some embodiments.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

One of the biggest challenges in modern large-scale retail operations is inventory stock level management. Streamlining the calculation of inventory target level to account for new trends and seasonal demand in a constantly changing retail landscape is key to gaining an edge in agility, customer satisfaction, and profitability over the competitors for a retailer. The decision on which products should be stocked and how many of each must be placed in stores and in the warehouse is an important driver of operational costs and efficiency for retail operations. A retailer can fulfill orders from customers based on a retail fulfillment network formed by various nodes, e.g. stores, warehouses, fulfillment centers, etc. Inventory management and optimization are fundamental design decisions for a retailer to determine how much safety stock is needed for each item at each node in the retail fulfillment network.

Currently, there is no unified approach on how to set optimized inventory targets at various operating granularity. Some existing methods assume that consumer demand, ordering, and inventory holding costs all remain constant over time, which contradicts today's dynamic retail landscape. Overall, these common one-size-fits-all approaches lead to suboptimal inventory allocation where both inventory starvation and overstock occur across different fulfilment nodes. As a result, human intervention is often required to override allocation recommendations, thus rendering large-scale automation useless.

One objective of various embodiments in the present disclosure is to develop systems and methods for automatically determining an inventory level that strikes a balance among inventory holding costs, shortage costs, profitability, and customer availability as required by business segments. The inventory level is optimized in consideration of a tradeoff between customer availability and business margin.

In some embodiments, an inventory target optimization system is disclosed to include a novel architecture to estimate supply chain lead time variability over an upcoming order cycle, and estimate consumer demand variability over a lead time and a review period. The system may also include an optimization engine that determines the service level and ideal stocking requirements to achieve an in-stock target as required by individual business units. In addition, the system may be designed for large-scale retail operations where the inventory level for all items across different assortments are calculated throughout their entire life cycle, and at all fulfillment nodes including physical stores, distribution, and fulfillment centers.

In some embodiments, a large-scale systematic approach is provided to optimize inventory target based on the tradeoff between operational costs and shortage costs at each item-node. In order to achieve such granularity and flexibility, more accurate inputs than simple aggregated statistics (e.g. mean, standard deviation) are required. In some examples, the system derives separate probability distributions for supply chain lead time variability and consumer demand variability based on fluctuations observed in the empirical data, thereby reducing reliance on point forecasts with unbounded error and allowing a mechanism to account for the changing input values over time.

In some embodiments, the disclosed approach improves the accuracy of optimization inputs by incorporating historical sales outlier removal, item-node seasonality detection, and new item lead time estimation that leverages historical observation of similar items as part of the comprehensive system design.

In various embodiments, a system including a processor and a non-transitory memory storing instructions is disclosed. The instructions, when executed, cause the processor to: obtain historical data of items at a fulfillment node in a network for a past time period; generate a supply chain lead time variability for an item at the fulfillment node based on the historical data; generate a consumer demand variability for the item at the fulfillment node based on the historical data and the supply chain lead time variability; generate, based on the supply chain lead time variability and the consumer demand variability, a recommended inventory level of the item in the fulfillment node for a future time period; and transmit the recommended inventory level to a computing device associated with the fulfillment node for inventory arrangement in the future time period.

In various embodiments, a computer-implemented method is disclosed. The computer-implemented method includes: obtaining historical data of items at a fulfillment node in a network for a past time period; generating a supply chain lead time variability for an item at the fulfillment node based on the historical data; generating a consumer demand variability for the item at the fulfillment node based on the historical data and the supply chain lead time variability; generating, based on the supply chain lead time variability and the consumer demand variability, a recommended inventory level of the item in the fulfillment node for a future time period; and transmitting the recommended inventory level to a computing device associated with the fulfillment node for inventory arrangement in the future time period.

In various embodiments, a non-transitory computer readable medium having instructions stored thereon is disclosed. The instructions, when executed by at least one processor, cause at least one device to perform operations including: obtaining historical data of items at a fulfillment node in a network for a past time period; generating a supply chain lead time variability for an item at the fulfillment node based on the historical data; generating a consumer demand variability for the item at the fulfillment node based on the historical data and the supply chain lead time variability; generating, based on the supply chain lead time variability and the consumer demand variability, a recommended inventory level of the item in the fulfillment node for a future time period; and transmitting the recommended inventory level to a computing device associated with the fulfillment node for inventory arrangement in the future time period.

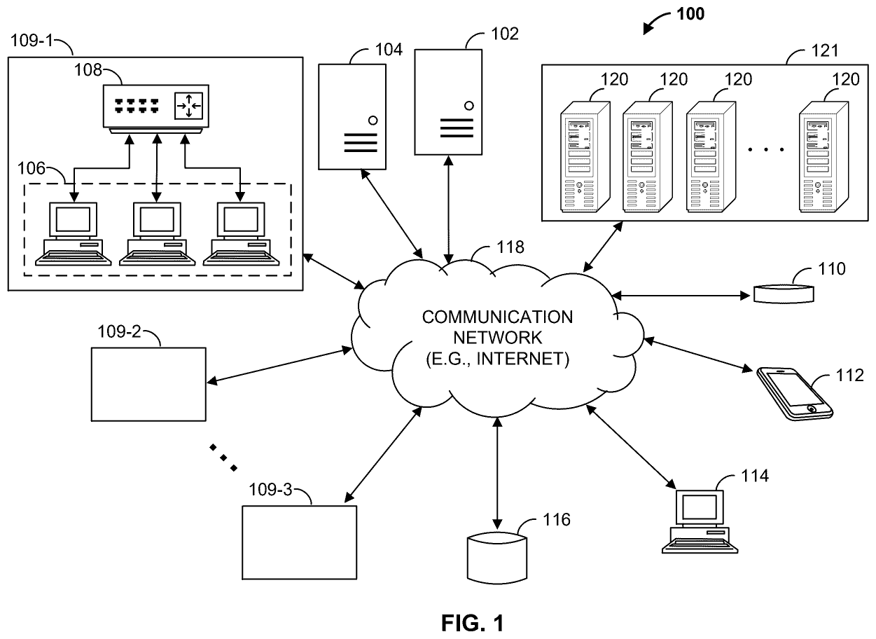

Turning to the drawings, FIG. 1 is a network environment 100 configured for optimizing inventory target level of products, in accordance with some embodiments. The network environment 100 includes a plurality of devices or systems that can communicate over one or more network channels, illustrated as a network cloud 118. For example, in various embodiments, the network environment 100 can include, but not limited to, an inventory level recommendation device 102, a server 104 (e.g., a web server or an application server), a cloud-based engine 121 including one or more processing devices 120, workstation(s) 106, a database 116, and one or more user computing devices 110, 112, 114 operatively coupled over the network 118. The inventory level recommendation device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the inventory level recommendation device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the inventory level recommendation device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the inventory level recommendation device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109 (or nodes 109).

The workstation(s) 106 can communicate with the inventory level recommendation device 102 over the communication network 118. The workstation(s) 106 may send data to, and receive data from, the inventory level recommendation device 102. For example, the workstation(s) 106 may transmit data identifying transactions, inventory, assortment, supply chain data and/or waste data at the one or more fulfillment nodes 109 to the inventory level recommendation device 102. The workstation(s) 106 may also transmit other data related to the one or more fulfillment nodes 109 to the inventory level recommendation device 102.

Although FIG. 1 illustrates three user computing devices 110, 112, 114, the network environment 100 can include any number of user computing devices 110, 112, 114. Similarly, the network environment 100 can include any number of the inventory level recommendation devices 102, the processing devices 120, the workstations 106, the fulfillment nodes 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer's website, hosted by the server 104. The server 104 may capture user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the inventory level recommendation device 102 over the communication network 118. The website may also allow the operator to add one or more of the items to an online shopping cart, and allow the customer to perform a “checkout” of the shopping cart to purchase the items. In some examples, the server 104 transmits purchase data identifying items the customer has purchased from the website to the inventory level recommendation device 102.

In some embodiments, an associate (or a manager or a store owner) of a retail store of a retailer may operate one of the user computing devices 110, 112, 114 to access an application programming interface (API) hosted by the server 104. The associate may, via the API, view: inventory data of items at the retail store, sales data of items at the retail store, forecast data indicating future customer demand and supply chain data, and recommendation data indicating how much inventory level should be maintained for a given item at the retail store. The associate may provide feedback data to the inventory level recommendation device 102, to indicate an effectiveness of these recommendations. The API may capture these activities of the associate as user session data or as they are, and transmit these activities to the inventory level recommendation device 102 over the communication network 118.

In some examples, the inventory level recommendation device 102 may receive a recommendation request from one of the fulfillment nodes 109 or from an associate of the fulfillment node. The recommendation request may be sent standalone or together with data associated with the fulfillment node (e.g. a store, a warehouse, a fulfillment center or a distribution center of the retailer), to seek recommendations on an inventory level of a given item at the fulfillment node for a future time period. In response, the inventory level recommendation device 102 generates recommendation data indicating an optimal inventory level of the given item at the fulfillment node for the future time period, and transmits the recommendation data to the fulfillment node or to the associate of the fulfillment node. In some embodiments, the recommendation data is generated based on a supply chain lead time variability for the item and a consumer demand variability for the item. The inventory level recommendation device 102 may receive feedback data from the fulfillment node or the associate regarding effectiveness of the recommendations, and generate and provide updated recommendation data based on the feedback.

In some embodiments, the inventory level recommendation device 102 is further operable to communicate with the database 116 over the communication network 118. For example, the inventory level recommendation device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the inventory level recommendation device 102, in some examples, the database 116 can be a local storage device, such as a hard drive, a non-volatile memory, or a USB stick. For example, the inventory level recommendation device 102 may store online purchase data received from the server 104 in the database 116. The inventory level recommendation device 102 may receive in-store purchase data and node related data from different fulfillment nodes 109 and store them in the database 116. The inventory level recommendation device 102 may also receive from the server 104 user session data identifying events associated with browsing sessions, and may store the user session data in the database 116. The inventory level recommendation device 102 may also compute recommendation data in response to an recommendation request received from the server 104 (or the fulfillment nodes 109), and may store the recommendation data in the database 116.

In some examples, the inventory level recommendation device 102 generates and/or updates different models (e.g., machine learning models, deep learning models, statistical models, algorithms, etc.) for optimizing inventory target level of products. The inventory level recommendation device 102 may generate training data for the models based on data including but not limited to: item features, store features, historical sale data, historical inventory data, historical recommendation data, and historical feedback data. The inventory level recommendation device 102 trains the models based on their corresponding training data, and stores the models in a database, such as in the database 116 (e.g., a cloud storage). The models, when executed by the inventory level recommendation device 102, allow the inventory level recommendation device 102 to generate recommendations for optimizing target inventory levels for different items for inventory arrangement in a future time period.

In some examples, the inventory level recommendation device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the inventory level recommendation device 102 may generate insights and recommendations for inventory target level optimization.

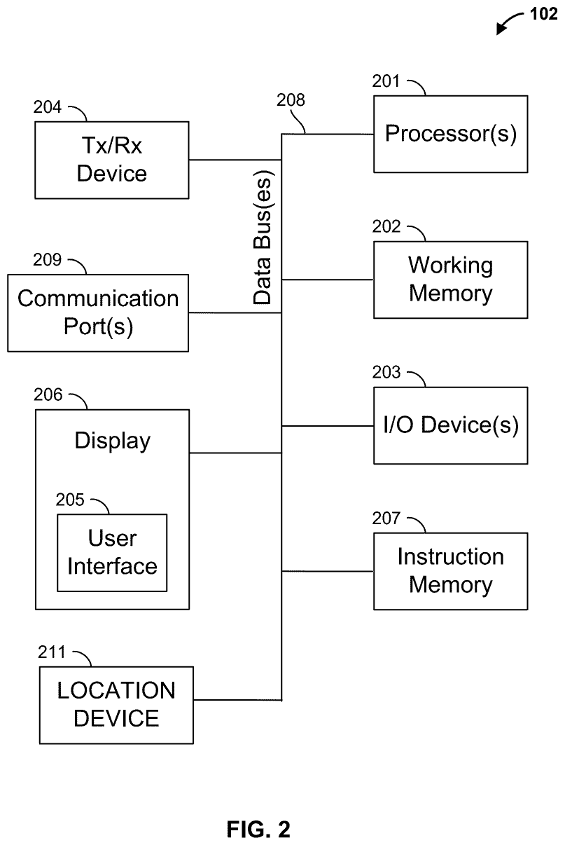

FIG. 2 illustrates a block diagram of an inventory level recommendation device, e.g. the inventory level recommendation device 102 of FIG. 1, in accordance with some embodiments. In some embodiments, each of the inventory level recommendation device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the inventory level recommendation device 102 can be combined, omitted, and/or replicated. In addition, it will be appreciated that additional elements other than those illustrated in FIG. 2 can be added to the inventory level recommendation device 102.

As shown in FIG. 2, the inventory level recommendation device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the inventory level recommendation device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the inventory level recommendation device 102 can include a single memory unit to operate as both instruction memory and working memory. Further, although embodiments are discussed herein including non-volatile memory, it will be appreciated that the inventory level recommendation device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 allows communications with the cellular network. In some embodiments, the transceiver 204 is selected based on the type of the communication network 118 the inventory level recommendation device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the inventory level recommendation device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 may couple the inventory level recommendation device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the inventory level recommendation device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the inventory level recommendation device 102 may determine a local geographical area (e.g., town, city, state, etc.) of its position.

In some embodiments, the inventory level recommendation device 102 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

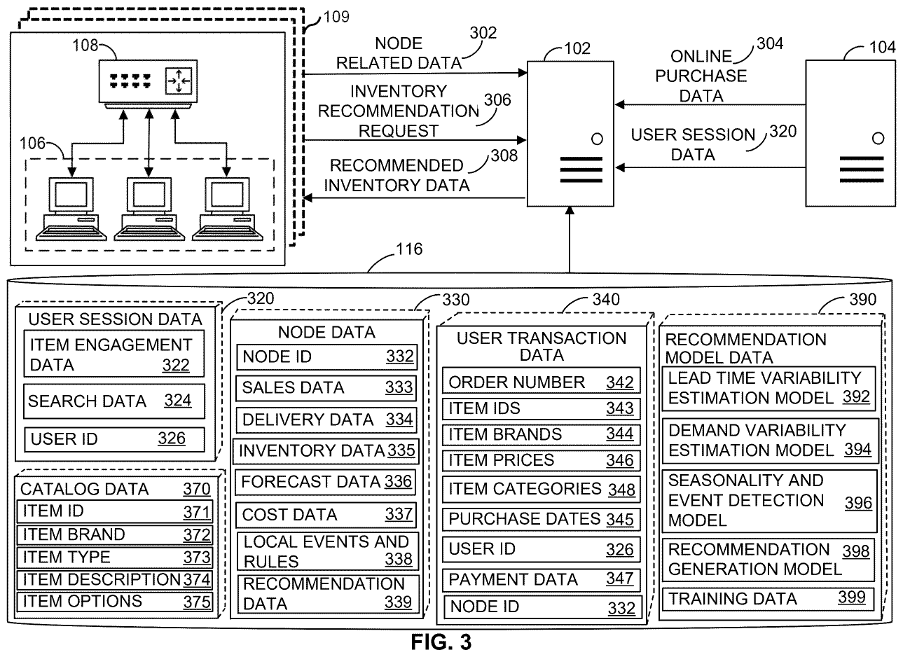

FIG. 3 is a block diagram illustrating various portions of a system for optimizing inventory target level of products, e.g. the system shown in the network environment 100 of FIG. 1, in accordance with some embodiments. As indicated in FIG. 3, the inventory level recommendation device 102 may receive user session data 320 from the server 104, and store the user session data 320 in the database 116. The user session data 320 may identify, for each user (e.g., customer, seller, associate), data related to that user's browsing session, such as when browsing a retailer's webpage hosted by the server 104. In some embodiments, the system may not utilize all of the components and data shown in FIG. 3 for recommending and optimizing inventory target levels for items.

In some examples, the user session data 320 may include item engagement data 322, search data 324, and user ID 326 (e.g., a customer ID, seller ID, associate ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The inventory level recommendation device 102 may also receive online purchase data 304 from the server 104, which identifies and characterizes one or more online purchases, such as purchases made by the user and other users via a retailer's website hosted by the server 104. The inventory level recommendation device 102 may also receive node related data 302 from the fulfillment nodes 109, which identifies and characterizes one or more in-store purchases, product location data, inventory data, and assortment data related to each of the fulfillment nodes 109. In some embodiments, the node related data 302 may also indicate other information about the fulfillment nodes 109.

The inventory level recommendation device 102 may parse the node related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, and node ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some examples, the inventory level recommendation device 102 receives an inventory recommendation request 306 from a fulfillment node 109. The inventory recommendation request 306 may be associated with a request for a recommended inventory target level for an item offered for sale at the fulfillment node 109 in a future time period. For example, a retailer may be associated with a plurality of physical stores for selling products in-store. The inventory recommendation request 306 is to seek a recommendation on an inventory stock level planned for an item in one of the stores for the future time period, to ensure meeting future customer demands for the item and not increasing costs for item storage, holding etc. In some embodiments, the recommended inventory stock level should be optimized based on a tradeoff of: inventory holding costs, shortage costs, profitability, and customer availability in a given business segment.

In response, the inventory level recommendation device 102 may obtain historical data of items at the fulfillment node 109 for a past time period. The inventory level recommendation device 102 may generate a supply chain lead time variability for the item at the fulfillment node 109 based on the historical data, and then generate a consumer demand variability for the item at the fulfillment node 109 based on the historical data and the supply chain lead time variability. In some embodiments, based on the supply chain lead time variability and the consumer demand variability, the inventory level recommendation device 102 generates recommended inventory data 308 including a recommended inventory level of the item in the fulfillment node 109 for the future time period, and transmits the recommended inventory data 308 to the fulfillment node 109 for inventory arrangement in the future time period.

In some embodiments, the inventory level recommendation device 102 may generate node data 330 based on the node related data 302 and the recommended inventory data 308. In some examples, the node data 330 may include, for each node, one or more of: the node ID 332 of the node, sales data 333 indicating data of historical sales for each item in the node, delivery data 334 indicating data of historical deliveries of each item to and from the node, inventory data 335 identifying and charactering an inventory status for each item in the node, forecast data 336 identifying forecasts of future data for each item in the node, cost data 337 identifying and charactering various costs associated with inventory arrangement and optimization at the node, local events and rules 338 indicating information related to events, holidays, and government rules that are local to the node, and recommendation data 339 indicating recommended inventory target levels for items at the node.

The database 116 may also store recommendation model data 390 identifying and characterizing one or more models and related data for optimizing inventory target level of products. For example, the recommendation model data 390 may include: a lead time variability estimation model 392, a demand variability estimation model 394, a seasonality and event detection model 396, a recommendation generation model 398 and training data 399. In various embodiments, the recommendation model data 390 includes any number of the lead time variability estimation models 392, the demand variability estimation models 394, the seasonality and event detection models 396, and the recommendation generation models 398.

The lead time variability estimation model 392 in this example can be used to determine or estimate a supply chain lead time variability of an item at a node. A lead time in supply chain may refer to an amount of time from a point when the node places an order of an item (e.g. from another node or the manufacturer) to a point when the order is delivered to the node (or to a specific location of the node). For example, after a store determines to increase its inventory for an item, the store submits an order for a number of the items. If it takes 10 days for the ordered items to arrive at the node (or arrive at a designated lane in the node), the lead time for the item is 10 days.

In some embodiments, the lead time variability estimation model 392 can be used to determine historical delivery data of items to a fulfillment node, and compute historical lead time errors based on the historical delivery data. Each of the historical lead time errors represents a time difference between a historical delivery time of a delivery and a committed delivery time of the delivery. In some embodiments, the lead time variability estimation model 392 includes a first probability distribution representing the supply chain lead time variability for the item at the fulfillment node, where the first probability distribution is generated based on the historical lead time errors.

The demand variability estimation model 394 can be used to determine or estimate a consumer demand variability of an item at a fulfillment node. In some examples, the demand variability estimation model 394 can be used to detect and remove abnormal sale records from the historical sale data of the item at the fulfillment node to create filtered historical sale data, and then determine the consumer demand variability for the item at the fulfillment node based on the filtered historical sale data and the supply chain lead time variability. In some examples, the demand variability estimation model 394 includes a plurality of probability distributions representing the consumer demand variability for the item at the fulfillment node. The probability distributions may be generated based on the filtered historical sale data. Each of the probability distributions may be generated over a respective one of a plurality of most probable lead time and review (LTR) periods for the item at the fulfillment node.

The seasonality and event detection model 396 in this example can be used to determine or detect whether an item is a seasonal or event-driven item. In some examples, a seasonal or event-driven item is an item whose sale amount is likely to be driven by seasonality or specific holidays or events, such that its sales data fluctuates greatly along time. In some embodiments, the determination of whether an item is a seasonal or event-driven item is input to the demand variability estimation model 394. For example, the demand variability estimation model 394 can be used to generate the plurality of probability distributions based on the determination.

The recommendation generation model 398 in this example can be used to generate recommendation data regarding the inventory target levels. In some examples, the recommendation generation model 398 may be used to combine the plurality of probability distributions representing the consumer demand variability for the item at the fulfillment node to generate a combined probability distribution based on likelihoods of the plurality of most probable LTR periods, and generate a shortage cost function of different inventory levels of the item in the fulfillment node for the future time period based on the combined probability distribution and a predetermined shortage cost per unit of the item. In addition, the recommendation generation model 398 may be used to determine a holding cost function of different inventory levels of the item in the fulfillment node for the future time period, generate a cost function based on the shortage cost function and the holding cost function, and minimize the cost function to generate the recommended inventory level of the item in the fulfillment node for the future time period.

In some embodiments, one or more of the lead time variability estimation models 392, the demand variability estimation models 394, the seasonality and event detection models 396, and the recommendation generation models 398 can be implemented as a machine learning model. The training data 399 may include data utilized for training one or more of the lead time variability estimation models 392, the demand variability estimation models 394, the seasonality and event detection models 396, and the recommendation generation models 398. In some examples, the training data 399 may be formed based on: item features, store features, historical or labelled sale data, historical or labelled inventory data, historical or labelled recommendation data, and historical feedback data, obtained from either real data or synthetic data.

In some embodiments, the inventory level recommendation device 102 may assign one or more of the above described operations to a different processing unit or virtual machine hosted by one or more processing devices 120. Further, the inventory level recommendation device 102 may obtain the outputs of the these assigned operations from the processing units, and generate the recommendation data 308 based on the outputs.

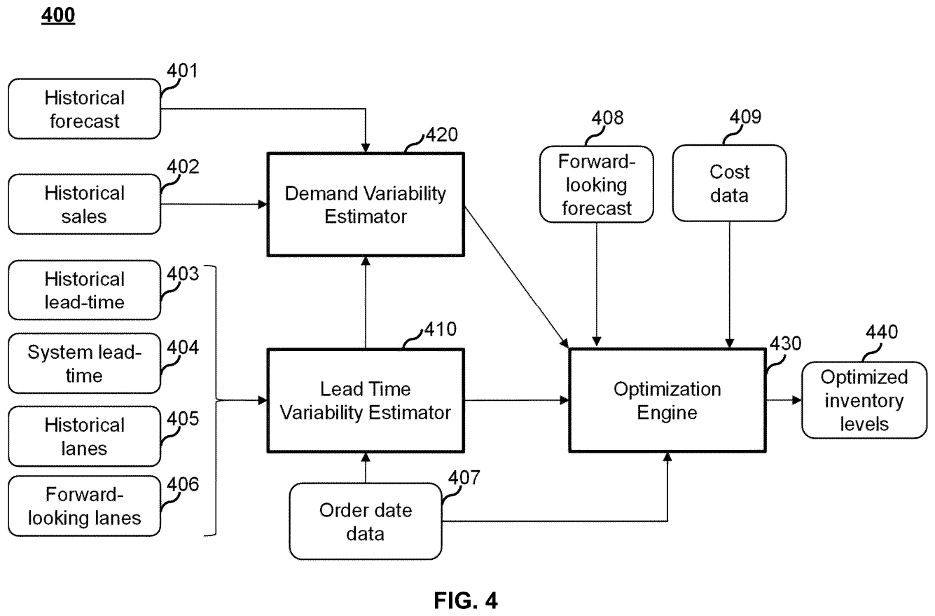

FIG. 4 illustrates an example architecture of a system 400 for optimizing product inventory target level, in accordance with some embodiments. In some embodiments, the system 400 can be implemented by one or more computing devices, such as the inventory level recommendation device 102, the server 104, and/or the cloud-based engine 121 of FIG. 1.

As shown in FIG. 4, the system 400 in this example includes a lead time variability estimator 410, a demand variability estimator 420, and an optimization engine 430. The lead time variability estimator 410 can obtain historical data of items at a fulfillment node in a network for a past time period, and generate a supply chain lead time variability for an item at the fulfillment node based on the historical data. The fulfillment node may comprise at least one of: a store, a warehouse, a fulfillment center, or a distribution center. In some embodiments, the lead time variability estimator 410 can determine, based on the historical data, historical delivery data of the items to the fulfillment node, and compute historical lead time errors based on the historical delivery data. Each of the historical lead time errors represents a time difference between a historical delivery time of a delivery and a committed delivery time of the delivery. The lead time variability estimator 410 may then generate, based on the historical lead time errors, a first probability distribution representing the supply chain lead time variability for the item at the fulfillment node.

An item being delivered late to a node is one key contributor to the need for a safety stock of the item. In some embodiments, an inventory target level for an item can be determined based on a forecast demand for the item and the determined safety stock of the item. When the lead time for the delivery of that item exceeds an agreed lead time by D day(s), a lead time error for the item is determined to be D day(s). The negative lead time errors (i.e. being delivered early) may or may not be modeled depending on the business considerations. In some embodiments, the system 400 treats early deliveries as being on-time for lead time variability estimation and inventory level recommendation.

In some embodiments, the result of lead time variability estimation is a probability distribution that allows to sample, for a particular item-node combination and a particular delivery, the number of days by which this delivery will be late (or early), or whether it will be on time. This sampling will later be used to create different scenarios for inventory level optimization.

As shown in FIG. 4, the lead time variability estimator 410 in this example receives historical lead-time data 403, system lead-time data 404, historical lanes data 405 and forward-looking lanes data 406. The historical lead-time data 403 includes lead times that historically happened for a given item-node combination (i.e. for a given item at a given fulfillment node). The system lead-time data 404 includes lead times committed by vendors for a given item-node combination (i.e. for a given item at a given fulfillment node). The historical lanes data 405 includes data related to the lanes that were previously allocated to carry the given item at the given fulfillment node. The forward-looking lanes data 406 includes data related to lanes that will be allocated to a given item-node combination.

In some embodiments, the lead time variability estimator 410 can estimate the lead time variability based on the received data. In some embodiments, the lead time variability estimator 410 estimates a total lead time and review (LTR) period for a given item-node combination. The LTR period includes a lead time period and a review period for the given item-node combination. A review period may refer to a time interval between successive reviews of inventory levels or between successive orders to maintain inventory levels, for the given item-node combination. The review period can be very item dependent or category dependent. As shown in FIG. 4, the lead time variability estimator 410 may receive order date data 407 for the given item-node combination, and determine the review period for the given item-node combination based on the order date data 407. In some embodiments, the lead time variability estimator 410 may generate and send the estimated lead time variability data to the demand variability estimator 420 for estimating demand variability and to the optimization engine 430 for generating optimized inventory target levels.

In some embodiments, the demand variability estimator 420 may generate a consumer demand variability for the item at the fulfillment node based on the historical data and the supply chain lead time variability estimated by the lead time variability estimator 410. In some embodiments, the demand variability estimator 420 may first determine, based on the historical data, historical sale data of the item at the fulfillment node, and then detect abnormal sale records in the historical sale data. After removing the abnormal sale records from the historical sale data, the demand variability estimator 420 can create filtered historical sale data of the item at the fulfillment node. Then, the demand variability estimator 420 may determine the consumer demand variability for the item at the fulfillment node based on the filtered historical sale data and the supply chain lead time variability estimated by the lead time variability estimator 410.

Estimating the variability of consumer demand simply based on a statistical variance of the sales data within a fixed time window fails to account for the ebbs and flows in demand for seasonal and event-driven items, which correspond to the time periods when the forecast error tends to fluctuate greatly. The resulting statistical variance is inevitably inflated, which can in turn lead to overestimation of safety stock downstream.

The demand variability estimator 420 in this example can detect and subsequently remove any abnormal or erroneous sales records beforehand. In addition, the demand variability estimator 420 estimates the demand not only over the mean lead time and review (LTR) period but also accounting for its variance observed historically, which enables the estimated demand variability to cover longer than expected upstream supply chain delays (e.g. transportation delays due to severe weather).

As shown in FIG. 4, the demand variability estimator 420 in this example receives historical forecast data 401 and historical sales data 402. The historical forecast data 401 includes forecast data previously provided for a given item-node combination, e.g. historical demand forecast for the given item-node combination. The historical sales data 402 includes data related to sales that previously happened to the given item-node combination. In some embodiments, a node may include many low selling items whose sales are slow and at a very low volume, such that the forecast of these items may carry lots of errors. As such, the demand variability estimator 420 will treat these items specially before generating the demand variability estimation. In some embodiments, the demand variability estimator 420 may generate and send the estimated demand variability data to the optimization engine 430 for generating optimized inventory target levels.

In some embodiments, the optimization engine 430 may generate, based on the supply chain lead time variability estimated by the lead time variability estimator 410 and the consumer demand variability estimated by the demand variability estimator 420, optimized inventory target levels 440 of items at nodes for the future time period, and transmit the optimized inventory target levels 440 to the corresponding nodes for inventory arrangement in the future time period.

In some embodiments, the optimization engine 430 utilizes numerical optimizations to select the optimal inventory level for a given item-node combination, while satisfying specific constraints on how the inventory level is set. The optimal inventory level may incorporate uncertainty from the aforementioned lead time variability and demand variability. In some embodiments, these two sources of uncertainty are used in a random sampling process to generate a scenario representing a possible outcome of the underlying random processes. Executing this sampling process repeatedly can provide a set of scenarios that represent the distribution of possible inventory outcomes, falling both above and below the forecast demand. One way to conceptualize this distribution is to determine excess demand. Choosing a point (i.e., inventory variability level) in this distribution implies a safety stock. Scenarios falling below this point would have all demand covered by the safety stock value, while those above this point would have resulted in lost sales. The optimization engine 430 may choose this point to achieve specific business objectives.

As shown in FIG. 4, the optimization engine 430 in this example receives the order date data 407, forward-looking forecast data 408 and cost data 409. The forward-looking forecast data 408 includes forecast data for a given item-node combination in a future time period, e.g. future demand forecast for the given item-node combination. The cost data 409 includes data related to various costs, e.g. holding cost, lost sale cost, etc., associated with the given item-node combination. In some embodiments, the optimization engine 430 generates the optimized inventory levels 440 each for a given item-node combination, based on the order date data 407, the forward-looking forecast data 408, the cost data 409, as well as the results received from the lead time variability estimator 410 and the demand variability estimator 420.

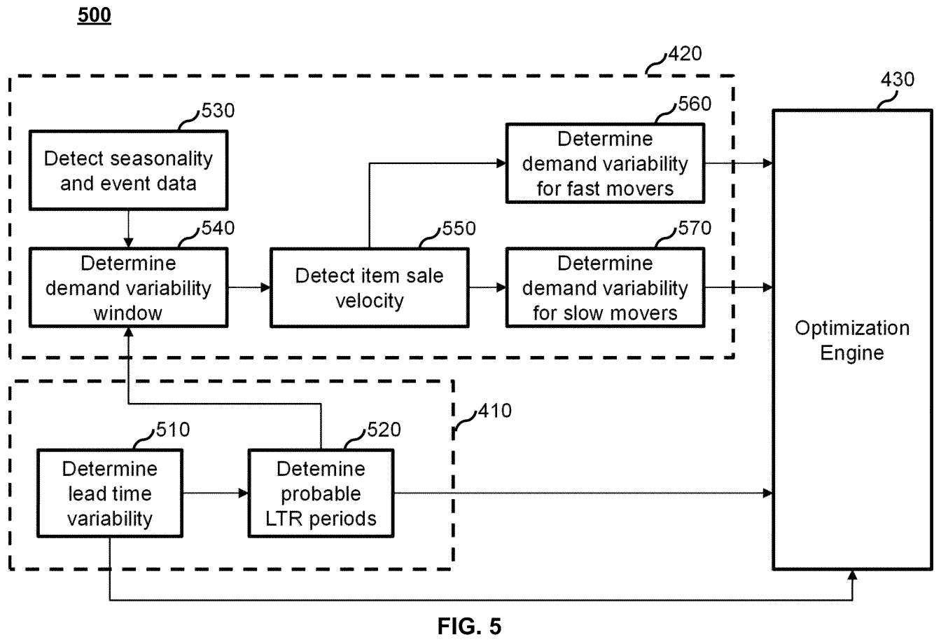

FIG. 5 illustrates an example process 500 performed by a system for optimizing product inventory target level, in accordance with some embodiments. In some embodiments, the process 500 can be implemented by the lead time variability estimator 410, the demand variability estimator 420 and the optimization engine 430 in FIG. 4. In some embodiments, the process 500 can be carried out by a system including one or more computing devices, such as the inventory level recommendation device 102, the server 104, and/or the cloud-based engine 121 of FIG. 1.

As shown in FIG. 5, the process 500 starts from operation 510, where the lead time variability estimator 410 determines a lead time variability for a given item-node combination. In some embodiments, the lead time variability is represented by a first probability distribution generated based on historical lead time errors, each of which represents a time difference between a historical delivery time of a delivery and a committed delivery time of the delivery.

In some examples, the lead time variability estimator 410 can generate the first probability distribution by: grouping items in the fulfillment node into a plurality of clusters, and determining, among the plurality of clusters, a cluster including the item. In some embodiments, the items are grouped such that items in a same cluster are likely to be delivered together to the fulfillment node and share a same lead time error. The lead time variability estimator 410 may then generate, based on historical lead time errors of items in the determined cluster, the first probability distribution representing the supply chain lead time variability for the item at the fulfillment node.

Then at operation 520, the lead time variability estimator 410 can determine probable lead time and review (LTR) periods based on the first probability distribution generated at the operation 510. In some embodiments, the lead time variability estimator 410 determines both the first probability distribution representing the supply chain lead time variability for the item at the fulfillment node, and a second probability distribution representing a variability of review periods for re-loading the item at the fulfillment node. The lead time variability estimator 410 may generate, based on the first probability distribution and the second probability distribution, a third probability distribution representing a variability of LTR periods for the item at the fulfillment node. Based on the third probability distribution, the lead time variability estimator 410 may determine a plurality of most probable LTR periods whose probabilities are higher than a predetermined threshold. In some embodiments, the lead time variability estimator 410 may send the most probable LTR periods to the demand variability estimator 420 for determining demand variability and to the optimization engine 430 for generating optimized inventory target levels.

At operation 530, the demand variability estimator 420 may detect seasonality and event data, e.g. based on historical sales data. At operation 540, the demand variability estimator 420 may determine a demand variability window, e.g. based on the detected seasonality and event data detected at the operation 530 and the most probable LTR periods generated at the operation 520. In some embodiments, the demand variability window is a historical time window which gives a closest match to the current time frame, based on the detected seasonality and event data. In some embodiments, the length of the demand variability window may be determined based on the most probable LTR periods generated at the operation 520.

At operation 550, the demand variability estimator 420 may detect item sale velocity for items within the demand variability window to divide items into fast movers (items being sold fast) and slow movers (items being sold slowly or seldom being sold). At operation 560, the demand variability estimator 420 determines a demand variability for a fast mover, e.g. based on historical forecast errors. At operation 570, the demand variability estimator 420 determines a demand variability for a slow mover, e.g. based on sales data instead of forecast error. In some embodiments, whether an item is a fast mover or a slow mover, the demand variability estimator 420 generates a plurality of probability distributions representing the consumer demand variability for the item at the fulfillment node. Each of the plurality of probability distributions is generated over a respective one of the most probable LTR periods determined at the operation 520.

As shown in FIG. 5, the optimization engine 430 receives the results from the operations 510, 520, 560, 570, and generates a recommended inventory target level for an item at a fulfillment node. In some embodiments, the optimization engine 430 combines the plurality of probability distributions representing the consumer demand variability for the item at the fulfillment node to generate a combined probability distribution based on likelihoods of the plurality of most probable LTR periods. Based on the combined probability distribution and a predetermined shortage cost per unit of the item, the optimization engine 430 may generate a shortage cost function of different inventory levels of the item in the fulfillment node for the future time period. Then, the optimization engine 430 can determine a holding cost function of different inventory levels of the item in the fulfillment node for the future time period, and generate a cost function based on the shortage cost function and the holding cost function. By minimizing the cost function, the optimization engine 430 may generate the recommended inventory target level of the item in the fulfillment node for the future time period.

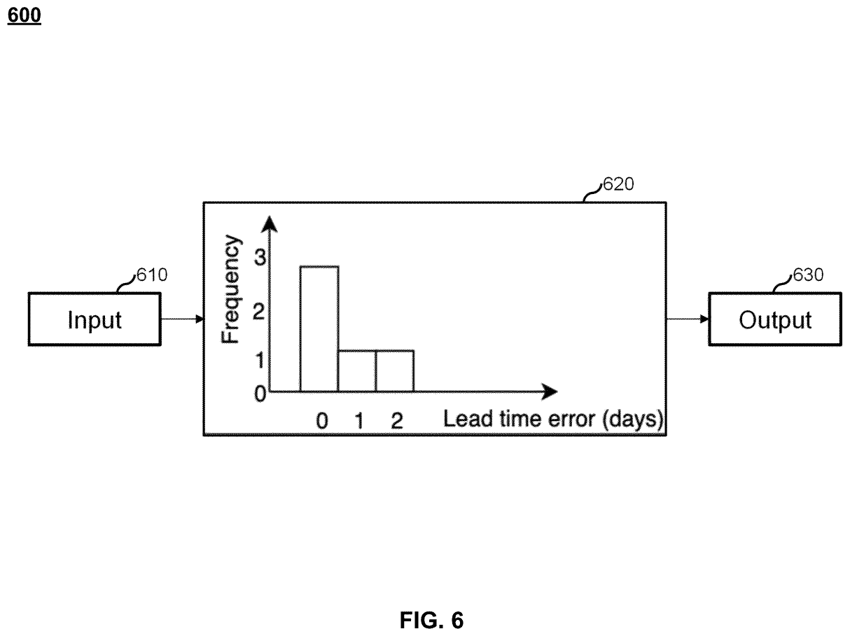

FIG. 6 illustrates an example process 600 for lead time variability estimation, in accordance with some embodiments. In some embodiments, the process 600 can be implemented as part of the operation 510 in FIG. 5. In some embodiments, the process 600 can be carried out by one or more computing devices, such as the inventory level recommendation device 102, the server 104, and/or the cloud-based engine 121 of FIG. 1.

In some embodiments, the modeling of lead time variability estimation can be achieved by simply taking all historical deliveries and building a probability distribution based on the historical lead time errors, whether an empirical distribution or another more specific distribution (e.g. Poisson). In some embodiments, to improve accuracy, the modeling may also be done by grouping related types of items together. For example, all frozen food items are grouped together, as they are likely to be delivered on the same truck and share the same lead time error.

As shown in FIG. 6, a distribution 620 of lead time errors can be fit based on input data 610, which may include historical lead time error data of a plurality of items (e.g. an item pool) of a retailer. In some embodiments, different distributions are fit for different item groups. The output data 630 after fitting the distribution may include item groups matched with each corresponding lead time error distribution.

In some embodiments, the distribution 620 is a linear blended lead time error distribution utilizing data at different hierarchies (e.g. item, group, category, department, etc.). This is helpful to combat data sparsity, while maintaining data granularity. This also helps generating distributions for new items.

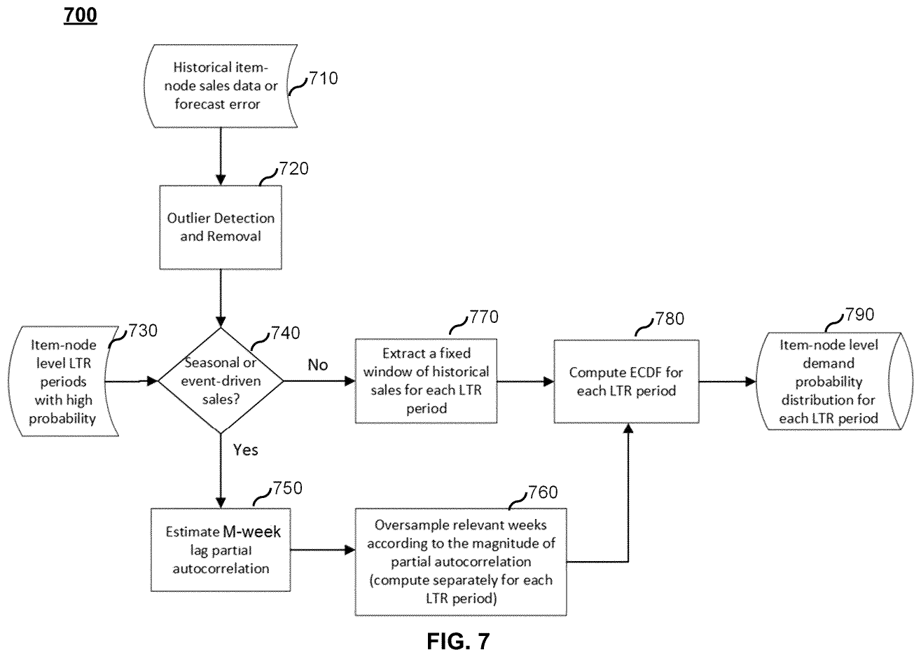

FIG. 7 illustrates an example process 700 for estimating item-node level demand variability, in accordance with some embodiments. In some embodiments, the process 700 can be implemented by the demand variability estimator 420 in FIG. 4. In some embodiments, the process 700 can be carried out by a system including one or more computing devices, such as the inventory level recommendation device 102, the server 104, and/or the cloud-based engine 121 of FIG. 1.

As shown in FIG. 7, the process 700 starts from operation 710, where the system obtains historical sales data and/or forecast error data for a given item-node combination. Then at operation 720, the system can detect and remove outliers from the obtained data to generate filtered historical sales data (or filtered forecast error data). In parallel to operations 710˜720, the system can also obtain or determine item-node level LTR periods with high probability, e.g. the most probable LTR periods (with probability larger than a predetermined threshold) generated at the operation 520 in FIG. 5.

At operation 740, the system determines whether the sales of an item are seasonal or event-driven sales. If the system determines that the item is a seasonal or event-driven item, or determines that the sales of an item are seasonal or event-driven sales, the system can compute a partial autocorrelation of the filtered historical sale data with its own time-lagged (e.g. lagged by M weeks) data at operation 750. Then at operation 760, the system may oversample values according to a magnitude of the partial autocorrelation to determine historical relevant periods (e.g. relevant weeks) that are similar to the future time period for sale of the item at the fulfillment node. Based on the determined relevant periods, the system can identify forecast errors of the item over the determined relevant periods in filtered forecast error data. In some embodiments, the system can compute historical forecast errors of the item at the fulfillment node based on the filtered historical sale data, where each of the historical forecast errors represents a demand difference between a historical demand of the item over a historical relevant period and a forecasted demand of the item over the historical relevant period. The process 700 may then go to operation 780. In some embodiments, the operations 750˜760 are performed for each probable LTR period.

If the system determines that the item is not a seasonal or event-driven item, or determines that the sales of an item are not seasonal or event-driven sales at the operation 740, the system can extract a fixed time window of the filtered historical sale data for a respective one of the plurality of most probable LTR periods to generate extracted historical sale data at operation 770. The process 700 may then go to operation 780 as well.

At operation 780, the system computes or fits a distribution, e.g. an empirical cumulative distribution function (ECDF), to generate item-node level demand probability distribution 790 for each probable LTR period. That is, the process 700 generates a plurality of probability distributions representing the consumer demand variability for the item at the fulfillment node. Each of the plurality of probability distributions is generated over a respective one of the plurality of most probable LTR periods. In some embodiments, for a seasonal or event-driven item, the probability distribution for each probable LTR period is generated by fitting a normal distribution to the historical forecast errors over the probable LTR period. In some embodiments, for an item that is not a seasonal or event-driven item, the probability distribution for each probable LTR period is generated by fitting a Poisson distribution to the extracted historical sale data over the probable LTR period.

In some embodiments, the variability of the demand that exceeds a prediction of the forecast is reflected by a forecast error. As such, the system may model the excess demand variability by the historical forecast error at the item-node level. However, the forecast for slow-selling items is typically inaccurate and resembles a flat line that reflects the moving average instead. Therefore, the system can model the demand variability for slow-selling items by directly using historical sales data instead. In both cases according to some embodiments, the system may represent the demand variability probability distribution by estimating an empirical cumulative distribution function (ECDF) using observed data, because such excess variability is often volatile and its shape does not fit any known probability distribution well even after data transformation.

The results of demand variability estimation are probability distributions that allow to simulate the forecast error (and actual sales) for any item-node combination, over an upcoming period being modeled. In various embodiments, the upcoming period may be between one day and a few weeks. An empirical probability distribution can be used, or more specific distributions can be fit such as a Poisson distribution for slow-moving items and a normal distribution for fast-moving items. Subsequent days can be modeled as independent, or demand (forecast error) over multiple days can be directly modeled.

In some embodiments, an optional step of outlier removal is performed to significantly improve the quality of the demand variability distributions. Sometimes an item's history includes a few days with particularly high sales due to a short-term promotion, a hurricane, or another exceptional event. In that case, this brief period of elevated demand may make the system maintain an unreasonably high amount of safety stock, even if those circumstances will almost certainly not be repeated. An example would be a historical spike in sales of test kits for COVID-19. The system can treat those sales spikes as outliers to be removed. This step is heuristic as the possible causes of an unrepeatable sales spike cannot be fully enumerated. Even promotions are sometimes not recorded in the system as promotions when employees forget to do so. In some examples, if the sales of an item for a particular day are much higher than the forecast for that day and much higher than the sales for the days immediately preceding or succeeding that day, by a difference beyond some threshold, this day becomes a marked outlier. The sales for that day can then be capped or even replaced with the forecast for that day. The system can carefully determine or calibrate the algorithm parameters to distinguish between seasonal sales spikes and outliers.

Regardless of the type of input data, the system can choose the historical periods (e.g. days, weeks) that are relevant to the upcoming time interval for calculating the safety stock. In some embodiments, due to the scale of big data, the system may automate the process of selecting the relevant periods rather than relying on human knowledge.

In some examples, the system may compute a partial autocorrelation of the input data time series with its own 56-week lagged values and oversample the values according to the magnitude of the partial autocorrelation of the respective lags. In this way, the system effectively gives more emphasis to the weeks that are related to the upcoming week that is concerned to calculate the safety stock. An empirical test shows that the accuracy of the demand probability distribution is improved significantly with this oversampling procedure, especially for seasonal and event-driven items (e.g. Thanksgiving related items, allergy medication, etc.) compared to using an approach of an arbitrary fixed window (e.g. the previous 365 days).

As discussed above, the demand variability estimation is based on the lead time variability estimation. The demand probability distribution is computed separately for each probable LTR period at the item-node level and stored in a database for downstream consumption for inventory target level optimization. For example, if the probable LTR periods are determined to be 5 days and 9 days, then the demand over a 5-day period will be aggregated and applied in a rolling fashion to obtain the data to estimate the ECDF over the relevant historical period, with the appropriate oversampling scheme applied. Another demand probability distribution for a 9-day LTR period for the same item-node will be computed and stored separately. The different demand probability distributions may be later combined together based on the probabilities of the different probable LTR periods. For example, a combined demand probability distribution can be determined based on a weighted summation of the different demand probability distributions, according to the probabilities of the different probable LTR periods.

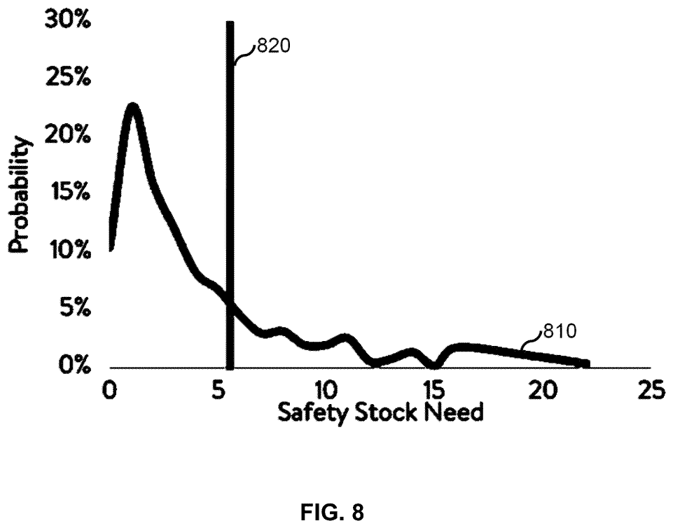

As discussed above, an optimal inventory target level for an item may be determined based on a balance among inventory holding costs, shortage costs, profitability, customer availability, etc. FIG. 8 illustrates an example probability distribution 810 computed for excess demand, in accordance with some embodiments. In this example, the minimum safety stock for the item is 0 unit. According to the probability distribution 810 with is an excess demand curve for the item, the item has different probabilities corresponding to different safety stock needs.

In some embodiments, the system can determine a shortage cost for the item based on the probability distribution 810 for a given service level of a future time period. A service level may indicate a level that the item is not out-of-service or out-of-stock. For example, a 95% service level means that an expectation of 5% of the time the item is running out of stock; a 90% service level means that an expectation of 10% of the time the item is running out of stock. In the example shown in FIG. 8, given a service level, e.g. 80%, the system can determine a threshold 820 of safety stock corresponding to the 80% service level. In this example, the demand for the item is expected to exceed the threshold 820 for the future time period with a 20% probability or at 20% of time. In other words, the demand for the item is expected to be less than the threshold 820 for the future time period with a 80% probability or at 80% of time.

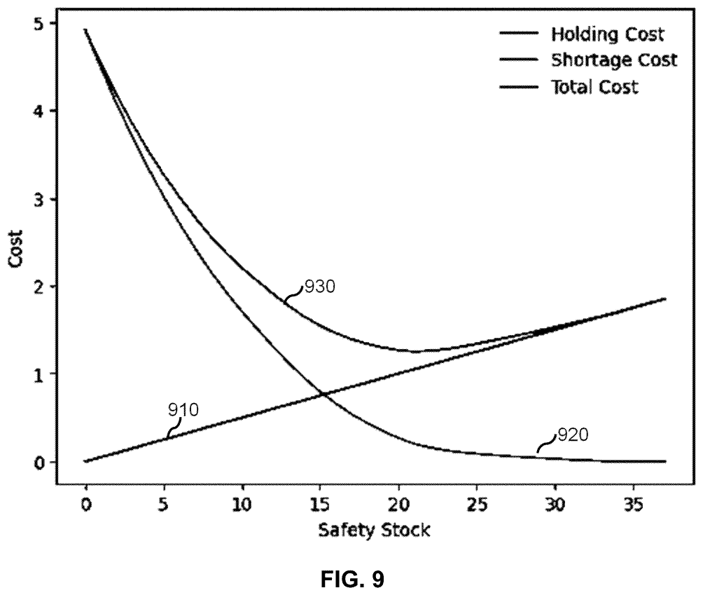

Based on a unit shortage cost (e.g. $1/unit), the system can determine an expected shortage cost (reflecting a cost including a lost sales cost due to shortage of the item compared to demand) for the item, given the threshold 820 corresponding to a given service level. In some embodiments, based the excess demand curve 810, the system can move the threshold 820 left and right according to different service levels, to compute an expected shortage cost curve, as shown in FIG. 9.

FIG. 9 illustrates example cost functions used for optimizing product inventory target level, in accordance with some embodiments. FIG. 9 shows a holding cost function 910, a shortage cost function 920, and a total cost function 930 for an item. As shown in FIG. 9, as the safety stock number for the item increases, the holding cost (cost of holding the item in stock) for the item increases proportionally according to the holding cost function 910. At the same time, as the safety stock number for the item increases, the shortage cost (e.g. determined based on the excess demand curve 810 in FIG. 8) for the item decreases according to the shortage cost function 920. The total cost function 930 in this example is a summation of the holding cost function 910 and the shortage cost function 920.

The system can determine an optimal safety stock or inventory target level for an item according to different manners. In some embodiments, the system can determine the minimum point of the total cost for the item according to the total cost function 930, and identify an optimal safety stock number corresponding to the minimum total cost point. In some embodiments, the system can determine a point where the holding cost and the shortage cost are equal for the item, i.e. the intersection point of the holding cost function 910 and the shortage cost function 920 in FIG. 9, and identify an optimal safety stock number corresponding to the intersection point. In some embodiments, the system can be flexible to accommodate other constraints, such as shelf space in the node, budget, etc. in the optimization step (e.g. via modification of the cost parameters, exclusion of the optimization search space, etc.). For example, the system may compute additional curves for shelf space availability, budget constraints, and then update the total cost function 930 to incorporate all of these costs and constraints, before finding its lowest point. In some embodiments, machine learning can be used to determine what costs and constraints are to be included in the total cost.

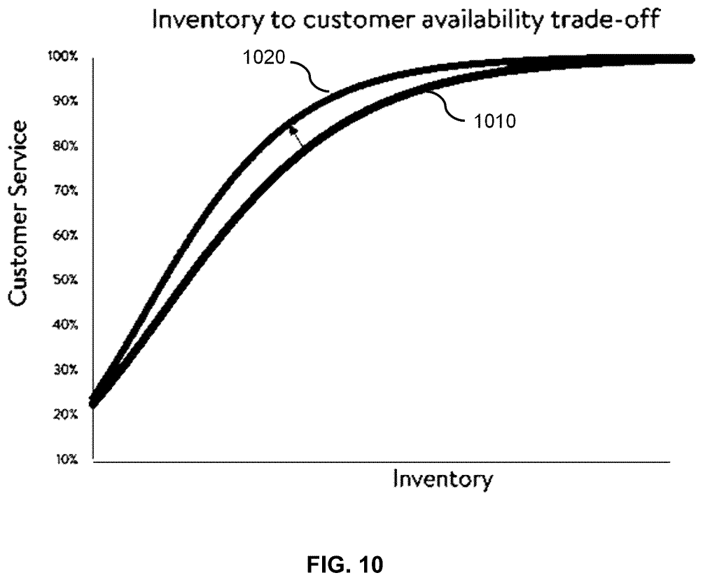

FIG. 10 illustrates example relationships between customer service and inventory levels, in accordance with some embodiments. While there is always a tradeoff between inventory level and customer service availability, one goal for a retailer to increase an expected customer service availability given a same inventory level, or to decrease a desired inventory level given a same customer service availability. Based on the methods disclosed herein for inventory target level optimization, the operating characteristic curve (i.e. the tradeoff curve between customer service and inventory levels) is improved from the curve 1010 to the curve 1020. That is, the system can achieve a better tradeoff: a higher customer service availability given a same inventory level, and a lower inventory level given a same customer service availability. Rather than moving along the curve 1010, the system will adjust the safety stock output along the new and better curve 1020. This may be done by adjusting the cost terms and/or other system parameters, e.g. per feedback from downstream systems or human operators.

In some embodiments, for inventory target level optimization, the system can utilize a general-purpose optimization engine to compute an optimal safety stock or inventory target level for an item, with a flexibility to modify the cost function to optimize. For example, if a retailer adds more storage capacity, the penalty for the unnecessary safety stock can be decreased to increase the amount of safety stock, and capture more of customer demand. This can be done granularly at the item-node level. In some examples, one location may have more storage for general merchandise while another location may have more refrigerators to store perishable items. The computed safety stock values can reflect and take advantage of the storage capacity information.

In some embodiments, the optimization step can also incorporate additional constraints such as setting a floor for service level, to ensure that an item always has at least a baseline level of availability even if it might not be most profitable solution. In some examples, this constraint can also be achieved by further tweaking the cost function to be optimized. The ability to add almost arbitrary logic at the optimization step allows for a wide range of business objectives to be mathematically expressed and achieved at the lowest possible expense, provided the relevant parameters such as the true storage costs or the true loss are correctly estimated when potential demand is not captured.

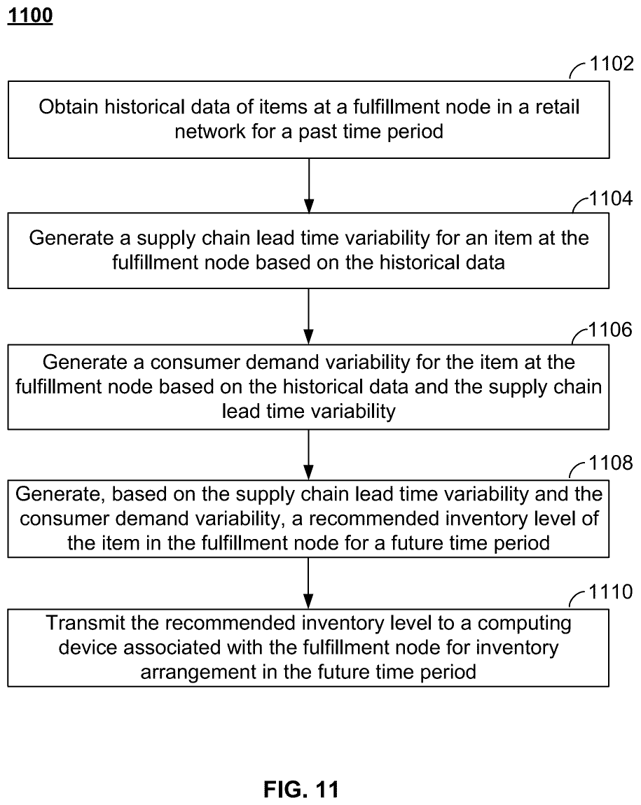

FIG. 11 shows a flowchart illustrating an example method 1100 for optimizing inventory target level of products, in accordance with some embodiments. In some embodiments, the method 1100 can be carried out by a system including one or more computing devices, such as the inventory level recommendation device 102 and/or the cloud-based engine 121 of FIG. 1. Beginning at operation 1102, historical data of items at a fulfillment node in a network are obtained for a past time period. At operation 1104, a supply chain lead time variability is generated for an item at the fulfillment node based on the historical data. At operation 1106, a consumer demand variability is generated for the item at the fulfillment node based on the historical data and the supply chain lead time variability. At operation 1108, based on the supply chain lead time variability and the consumer demand variability, a recommended inventory level of the item in the fulfillment node is generated for a future time period. The recommended inventory level is transmitted at operation 1110 to a computing device associated with the fulfillment node for inventory arrangement in the future time period.

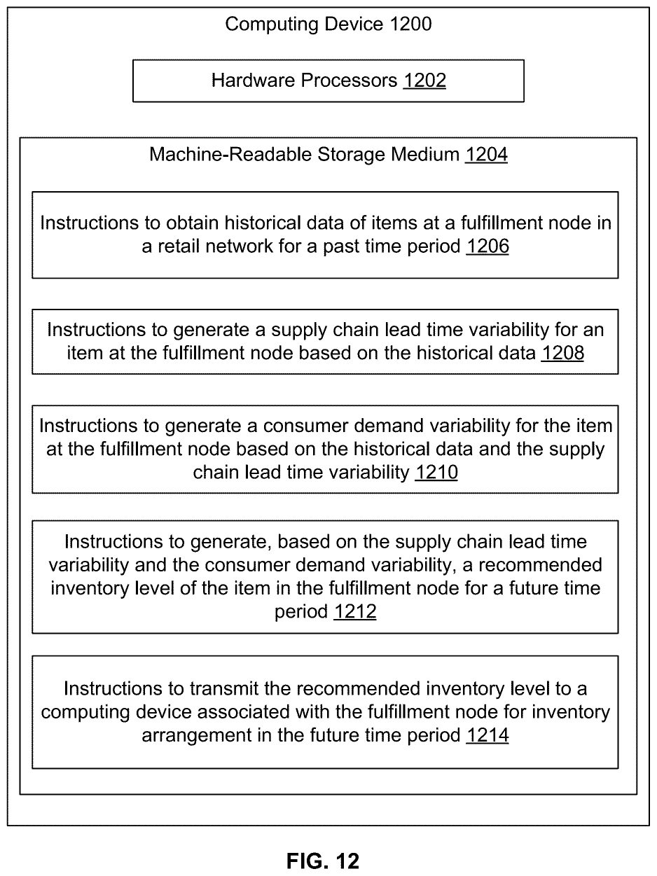

FIG. 12 depicts an example system 1200 (e.g. a computing device) for optimizing inventory target level of products, including a machine-readable medium 1204 encoded with example instructions executable by processing resource 1202, e.g. hardware processors, in accordance with some embodiments. In some implementations, the system 1200 may be useful for implementing aspects of the system 400 of FIG. 4 or performing the aspects of method 500 of FIG. 5. In some implementations, functionality described with respect to FIG. 4 and FIG. 5 may be included in the instructions encoded on machine-readable medium 1204.

The processing resource 1202 may include a microcontroller, a microprocessor, central processing unit core(s), an ASIC, an FPGA, and/or other hardware device suitable for retrieval and/or execution of instructions from the machine-readable medium 1204 to perform functions related to various examples. Additionally or alternatively, the processing resource 1202 may include or be coupled to electronic circuitry or dedicated logic for performing some or all of the functionality of the instructions described herein.

The machine-readable medium 1204 may be any medium suitable for storing executable instructions, such as RAM, ROM, EEPROM, flash memory, a hard disk drive, an optical disc, or the like. In some example implementations, the machine-readable medium 1204 may be a tangible, non-transitory medium. The machine-readable medium 1204 may be disposed within the system 1200 in which case the executable instructions may be deemed installed or embedded on the system. Alternatively, the machine-readable medium 1204 may be a portable (e.g., external) storage medium, and may be part of an installation package.

As described further herein below, the machine-readable medium 1204 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 12.

The machine-readable medium 1204 includes instructions 1206-1216. Instructions 1206, when executed, cause the processing resource 1202 to obtain historical data of items at a fulfillment node in a network for a past time period. The instructions 1208, when executed, cause the processing resource 1202 to generate a supply chain lead time variability for an item at the fulfillment node based on the historical data.

Instructions 1210, when executed, cause the processing resource 1202 to generate a consumer demand variability for the item at the fulfillment node based on the historical data and the supply chain lead time variability. The instructions 1212, when executed, cause the processing resource 1202 to generate, based on the supply chain lead time variability and the consumer demand variability, a recommended inventory level of the item in the fulfillment node for a future time period. The instructions 1214, when executed, cause the processing resource 1202 to transmit the recommended inventory level to a computing device associated with the fulfillment node for inventory arrangement in the future time period.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
obtain historical data of items at a fulfillment node in a network for a past time period,
generate a supply chain lead time variability for an item at the fulfillment node based on the historical data,
generate a consumer demand variability for the item at the fulfillment node based on the historical data and the supply chain lead time variability,
generate, based on the supply chain lead time variability and the consumer demand variability, a recommended inventory level of the item in the fulfillment node for a future time period, and
transmit the recommended inventory level to a computing device associated with the fulfillment node for inventory arrangement in the future time period.

2. The system of claim 1, wherein the fulfillment node comprises at least one of:
a store, a warehouse, a fulfillment center, or a distribution center.

3. The system of claim 1, wherein the supply chain lead time variability is generated based on:
determining, based on the historical data, historical delivery data of the items to the fulfillment node;
computing historical lead time errors based on the historical delivery data, wherein each of the historical lead time errors represents a time difference between a historical delivery time of a delivery and a committed delivery time of the delivery; and
generating, based on the historical lead time errors, a first probability distribution representing the supply chain lead time variability for the item at the fulfillment node.

4. The system of claim 3, wherein generating the first probability distribution comprises:
grouping the items into a plurality of clusters, wherein items in a same cluster are likely to be delivered together to the fulfillment node and share a same lead time error;
determining, among the plurality of clusters, a cluster including the item; and
generating, based on historical lead time errors of items in the determined cluster, the first probability distribution representing the supply chain lead time variability for the item at the fulfillment node.

5. The system of claim 1, wherein the consumer demand variability is generated based on:
determining, based on the historical data, historical sale data of the item at the fulfillment node;
detecting abnormal sale records in the historical sale data;
removing the abnormal sale records from the historical sale data to create filtered historical sale data of the item at the fulfillment node; and
determining the consumer demand variability for the item at the fulfillment node based on the filtered historical sale data and the supply chain lead time variability.

6. The system of claim 5, wherein determining the consumer demand variability comprises:
determining a first probability distribution representing the supply chain lead time variability for the item at the fulfillment node;
determining a second probability distribution representing a variability of review periods for re-loading the item at the fulfillment node;
generating, based on the first probability distribution and the second probability distribution, a third probability distribution representing a variability of lead time and review (LTR) periods for the item at the fulfillment node;
determining, based on the third probability distribution, a plurality of most probable LTR periods whose probabilities are higher than a predetermined threshold; and
generating, based on the filtered historical sale data, a plurality of probability distributions representing the consumer demand variability for the item at the fulfillment node, wherein each of the plurality of probability distributions is generated over a respective one of the plurality of most probable LTR periods.

7. The system of claim 6, wherein generating the plurality of probability distributions comprises:
determining that the item is a seasonal or event-driven item;
computing a partial autocorrelation of the filtered historical sale data with its own time-lagged data;
oversampling values according to a magnitude of the partial autocorrelation to determine historical relevant periods that are similar to the future time period for sale of the item at the fulfillment node;
computing historical forecast errors of the item at the fulfillment node based on the filtered historical sale data, wherein each of the historical forecast errors represents a demand difference between a historical demand of the item over a historical relevant period and a forecasted demand of the item over the historical relevant period;
generating, based on the historical forecast errors, the plurality of probability distributions representing the consumer demand variability for the item at the fulfillment node, wherein each of the plurality of probability distributions is generated by fitting a normal distribution to the historical forecast errors over a respective one of the plurality of most probable LTR periods.

8. The system of claim 6, wherein generating the plurality of probability distributions comprises:
determining that the item is not a seasonal or event-driven item; and
generating, based on the filtered historical sale data, the plurality of probability distributions representing the consumer demand variability for the item at the fulfillment node, wherein each of the plurality of probability distributions is generated by:
extracting a fixed time window of the filtered historical sale data for a respective one of the plurality of most probable LTR periods to generate extracted historical sale data, and
fitting a Poisson distribution to the extracted historical sale data over the respective one of the plurality of most probable LTR periods.

9. The system of claim 6, wherein the recommended inventory level is generated based on:
combining the plurality of probability distributions representing the consumer demand variability for the item at the fulfillment node to generate a combined probability distribution based on likelihoods of the plurality of most probable LTR periods;
generating, based on the combined probability distribution and a predetermined shortage cost per unit of the item, a shortage cost function of different inventory levels of the item in the fulfillment node for the future time period;
determining a holding cost function of different inventory levels of the item in the fulfillment node for the future time period;
generating a cost function based on the shortage cost function and the holding cost function; and
minimizing the cost function to generate the recommended inventory level of the item in the fulfillment node for the future time period.

10. A computer-implemented method, comprising:
obtaining historical data of items at a fulfillment node in a network for a past time period;
generating a supply chain lead time variability for an item at the fulfillment node based on the historical data;
generating a consumer demand variability for the item at the fulfillment node based on the historical data and the supply chain lead time variability;
generating, based on the supply chain lead time variability and the consumer demand variability, a recommended inventory level of the item in the fulfillment node for a future time period; and
transmitting the recommended inventory level to a computing device associated with the fulfillment node for inventory arrangement in the future time period.

11. The computer-implemented method of claim 10, wherein the fulfillment node comprises at least one of:
a store, a warehouse, a fulfillment center, or a distribution center.

12. The computer-implemented method of claim 10, wherein generating the supply chain lead time variability comprises:
determining, based on the historical data, historical delivery data of the items to the fulfillment node;
computing historical lead time errors based on the historical delivery data, wherein each of the historical lead time errors represents a time difference between a historical delivery time of a delivery and a committed delivery time of the delivery; and
generating, based on the historical lead time errors, a first probability distribution representing the supply chain lead time variability for the item at the fulfillment node.

13. The computer-implemented method of claim 12, wherein generating the first probability distribution comprises:
grouping the items into a plurality of clusters, wherein items in a same cluster are likely to be delivered together to the fulfillment node and share a same lead time error;
determining, among the plurality of clusters, a cluster including the item; and
generating, based on historical lead time errors of items in the determined cluster, the first probability distribution representing the supply chain lead time variability for the item at the fulfillment node.

14. The computer-implemented method of claim 10, wherein generating the consumer demand variability comprises:
determining, based on the historical data, historical sale data of the item at the fulfillment node;
detecting abnormal sale records in the historical sale data;
removing the abnormal sale records from the historical sale data to create filtered historical sale data of the item at the fulfillment node; and
determining the consumer demand variability for the item at the fulfillment node based on the filtered historical sale data and the supply chain lead time variability.

15. The computer-implemented method of claim 14, wherein determining the consumer demand variability comprises:
determining a first probability distribution representing the supply chain lead time variability for the item at the fulfillment node;
determining a second probability distribution representing a variability of review periods for re-loading the item at the fulfillment node;
generating, based on the first probability distribution and the second probability distribution, a third probability distribution representing a variability of lead time and review (LTR) periods for the item at the fulfillment node;
determining, based on the third probability distribution, a plurality of most probable LTR periods whose probabilities are higher than a predetermined threshold; and
generating, based on the filtered historical sale data, a plurality of probability distributions representing the consumer demand variability for the item at the fulfillment node, wherein each of the plurality of probability distributions is generated over a respective one of the plurality of most probable LTR periods.

16. The computer-implemented method of claim 15, wherein generating the plurality of probability distributions comprises:
determining that the item is a seasonal or event-driven item;
computing a partial autocorrelation of the filtered historical sale data with its own time-lagged data;
oversampling values according to a magnitude of the partial autocorrelation to determine historical relevant periods that are similar to the future time period for sale of the item at the fulfillment node;
computing historical forecast errors of the item at the fulfillment node based on the filtered historical sale data, wherein each of the historical forecast errors represents a demand difference between a historical demand of the item over a historical relevant period and a forecasted demand of the item over the historical relevant period;
generating, based on the historical forecast errors, the plurality of probability distributions representing the consumer demand variability for the item at the fulfillment node, wherein each of the plurality of probability distributions is generated by fitting a normal distribution to the historical forecast errors over a respective one of the plurality of most probable LTR periods.

17. The computer-implemented method of claim 15, wherein generating the plurality of probability distributions comprises:
determining that the item is not a seasonal or event-driven item; and
generating, based on the filtered historical sale data, the plurality of probability distributions representing the consumer demand variability for the item at the fulfillment node, wherein each of the plurality of probability distributions is generated by:
extracting a fixed time window of the filtered historical sale data for a respective one of the plurality of most probable LTR periods to generate extracted historical sale data, and
fitting a Poisson distribution to the extracted historical sale data over the respective one of the plurality of most probable LTR periods.

18. The computer-implemented method of claim 15, wherein generating the recommended inventory level comprises:
combining the plurality of probability distributions representing the consumer demand variability for the item at the fulfillment node to generate a combined probability distribution based on likelihoods of the plurality of most probable LTR periods;
generating, based on the combined probability distribution and a predetermined shortage cost per unit of the item, a shortage cost function of different inventory levels of the item in the fulfillment node for the future time period;
determining a holding cost function of different inventory levels of the item in the fulfillment node for the future time period;
generating a cost function based on the shortage cost function and the holding cost function; and
minimizing the cost function to generate the recommended inventory level of the item in the fulfillment node for the future time period.

19. A non-transitory computer readable medium having instructions stored thereon, wherein the instructions, when executed by at least one processor, cause at least one device to perform operations comprising:
obtaining historical data of items at a fulfillment node in a network for a past time period;
generating a supply chain lead time variability for an item at the fulfillment node based on the historical data;
generating a consumer demand variability for the item at the fulfillment node based on the historical data and the supply chain lead time variability;
generating, based on the supply chain lead time variability and the consumer demand variability, a recommended inventory level of the item in the fulfillment node for a future time period; and
transmitting the recommended inventory level to a computing device associated with the fulfillment node for inventory arrangement in the future time period.

20. The non-transitory computer readable medium of claim 19, wherein generating the recommended inventory level comprises:
generating, based on the consumer demand variability and a predetermined shortage cost per unit of the item, a shortage cost function of different inventory levels of the item in the fulfillment node for the future time period;
determining a holding cost function of different inventory levels of the item in the fulfillment node for the future time period;
generating a cost function based on the shortage cost function and the holding cost function; and
minimizing the cost function to generate the recommended inventory level of the item in the fulfillment node for the future time period.
